(19) United States
(12) Patent Application Publication
(10) Pub. No.: US 2015/0197636 A1
(43) Pub. Date: Jul. 16, 2015

(54) FREE RADICAL INITIATED METHYL METHACRYLATE-ARABIAN ASPHALTENE POLYMER COMPOSITES

(71) Applicant: King Fahd University of Petroleum and Minerals, Dhahran (SA)

(72) Inventor: Mohammad N. SIDDIQUI, Dhahran (SA)

(73) Assignee: King Fahd University of Petroleum and Minerals, Dhahran (SA)

(21) Appl. No.: 14/155,913

(22) Filed: Jan. 15, 2014

(51) Int. Cl. C08L 95/00; C08L 33/12

(52) U.S. Cl. CPC C08L 95/00; C08L 33/12

(57) ABSTRACT

A polymer-asphaltene composite matrix containing an Arabian heavy asphaltene which is a filler obtained from Arabian heavy residue. A method of synthesizing composites based on polymer-asphaltenes matrix with different amounts of Arabian heavy asphaltenes. The method includes mixing methyl methacrylate monomer with asphaltene and performing in-situ polymerization with dispersion of the asphaltene molecules into the styrene monomer mixture.

### BACKGROUND OF THE INVENTION

1. Field of the Disclosure

The present invention relates to a polymer asphaltene composite comprising a methyl methacrylate polymer and an Arabian heavy asphaltene, and a method of forming the polymer asphaltene composite. The addition of asphaltene as filler significantly improves the thermal stability and viscoelastic properties of the composites formed.

2. Description of Related Art

Polymer composites are mixtures of polymers with inorganic or organic additives. Thus, polymer composites contain two or more components and two or more phases. A modified polymer matrix is formed by incorporation of fillers and has micro- and macrostructures which possess unique physiochemical properties. Therefore, the main reasons behind using these fillers include enhancement of properties, overall cost reduction as relatively lesser amount of polymeric material is required, and improved processing characteristics which reduces the required energy and time.

The additives for polymer composites have been variously classified as reinforcements, fillers, or reinforcing fillers. Reinforcements, being much stiffer and stronger than the polymer, usually increase its modulus and strength. Thus, mechanical property modification may be considered as their primary function, although their presence may significantly affect thermal expansion, transparency, thermal stability, and so on. However, most fillers were considered as additives, which, because of their unfavorable geometrical features, surface area, or surface chemical composition, could only moderately increase the modulus of the polymer, whereas strength (tensile, flexural) remained unchanged or even decreased. Depending on the type of filler, other polymer properties could be affected; for example, melt viscosity could be significantly increased through the incorporation of fibrous materials. On the other hand, mold shrinkage and thermal expansion would be reduced, a common effect of most inorganic fillers.

Mascia (Xanthos M. (2010) Part 1 “Functional fillers for Plastics” 2^{nd} ed.—incorporated by reference in its entirety) first proposed a more convenient scheme for plastic additives according to their specific function, such as their ability to modify mechanical, electrical, or thermal properties, flame retardancy, processing characteristics, solvent permeability, or simply formulation costs. Fillers, however, are multifunctional and may be characterized by a primary function and a plethora of additional functions.

Fan-Long Jin et al (Fan-Long Jin, Soo-Jin Park, Thermal properties of epoxy resin/filler hybrid composites, Polymer Degradation and Stability, Volume 97, Issue 11, November 2012, Pages 2148-2153—incorporated by reference in its entirety) investigated the thermal properties of epoxy resin/filler hybrid composites. Epoxy resin/filler hybrid composites were prepared by the melt blending of diglycidylether of bisphenol-A (DGEBA), as the epoxy resin, with nano-Al₂O₃ or nano-SiC particles, as the nanoscaled fillers. It was reported that the DSC curve peak temperature of both composites decreased with increasing filler content.

In another study, the submicron and nano-sized BaTiO₃ fillers slightly decreased the thermal decomposition temperature of the polymer matrix, while the nano-sized γ-LiAlO₂ filler improved to some extent the thermal stability of the polymer matrix (Zhaoyin Wen, Takahito Itoh, Takahiro Uno, Masataka Kubo, Osamu Yamamoto, Thermal, electrical, and mechanical properties of composite polymer electrolytes based on cross-linked poly(ethylene oxide-co-propylene oxide) and ceramic filler, (Abstract) Solid State Ionics, Volume 160, Issues 1-2, May 2003, Pages 141-148—incorporated by reference in its entirety). The thermal properties of pure poly(methyl methacrylate) (PMMA) and PMMA filled with 5%, 10%, 15% and 20% of nanornetric particles of titanium oxide (TiO₂) and ferric oxide (Fe₂O₃) were investigated and found that the thermal stability of the polymer is largely improved even for the lowest oxide content (A. Laachachi, M. Cochez, M. Ferriol, J. M. Lopez-Cuesta, E. Leroy, Influence of TiO₂ and Fe₂O₃ fillers on the thermal properties of poly(methyl methacrylate) (PMMA), Materials Letters, Volume 59, Issue 1, January 2005, Pages 36-39—incorporated by reference in its entirety).

Nakano et al (Hajime Nakano, Katsuya Shimizu, Seiji Takahashi, Akihiko Kono, Toshiaki Ougizawa, Hideo Horibe, Resistivity—temperature characteristics of filler-dispersed polymer composites, Polymer, Volume 53, Issue 26, 7 Dec. 2012, Pages 6112-6117—incorporated by reference in its entirety) studied composites containing carbon nano tube (CNT) conductive particle filler. The study developed a quantitative relationship between poly (vinylidene fluoride) (PVDF) polymer's thermal volume expansion. The equation to revise filler content at each temperature due to the considerable thermal volume expansion rate of PVDF polymer indicates that filler content decreased with rising temperature.

### BRIEF SUMMARY

An objective of the invention is a polymer asphaltene composite matrix comprising a methyl methacrylate polymer and an Arabian heavy asphaltene.

In one embodiment, the Arabian asphaltene is the only filler present.

Another objective of the invention is a method of synthesizing a composite based on polymer asphaltene matrix.

In one embodiment, the method comprises mixing methyl methacrylate monomer with asphaltene, and then polymerizing the methyl methacrylate.

In another embodiment, the polymerization is an in-situ polymerization.

In another embodiment of the invention, the method comprises heating the mixture of asphaltene and methyl methacrylate with stirring and adding a free radical initiator before polymerizing the reaction material.

### BRIEF DESCRIPTION OF THE DRAWINGS

FIG. 1 is a graph of overlaid FTIR spectra of neat MMA and its asphaltene composites.

FIG. 2 is a graph of DSC measurements of neat MMA and its asphaltene composites.

FIG. 3 is a graph of mass loss scans of MMA and its asphaltene composites.

FIG. 4 is a graph of DTGA scans of MMA and its asphaltene composites.

FIG. 5 is a graph of DMA scans of MMA composites showing the Storage modules E′.

FIG. 6 is a graph of DMA scans of MMA composites showing the Phase angle, tan δ=E″/E′.

### DETAILED DESCRIPTION

Asphaltene as used herein differs from asphalt, and refers to molecular substances that are found in crude oil, along with resins, aromatic hydrocarbons, and saturates. Asphaltenes are composed mainly of polyaromatic carbon ring units which may contain one or more of an oxygen, nitrogen, and sulfur heteroatoms, optionally combined with trace amounts of heavy metals, particularly chelated vanadium and nickel, and aliphatic side chains of various lengths. Asphaltene is insoluble in light n-paraffinic hydrocarbon, i.e. n-heptane, but is soluble in toluene.

Asphalt is a colloidal system similar to petroleum, but with lighter molecules removed. Asphalt can be fractionated into 4 major components: saturates, aromatics, resins and asphaltenes. The fractionated part of saturates and aromatics is considered as gas oil. Polarity of these four fractions can be arranged as:
saturates<aromatics<resin<asphaltenes.
   Asphalt is soluble in carbon disulfide. Due to the aromatics, asphalt is heavier than asphaltenes.

Asphaltenes generally impede producing, transporting and refining of crude oil resources for a variety of reasons; mitigation of deleterious effects requires a thorough knowledge of the chemical and physical properties of asphaltenes. In addition, the heavy ends of crude oils have many familiar applications related to protective coatings and road paving which can be enhanced by judicious application of asphaltene science. In spite of the wealth of information about asphaltenes, several fundamental properties are not known. The molecular weight of asphaltene molecules has been a matter of controversy for more than a decade.

In the present invention, the polymer asphaltene composite matrix comprises a methyl methacrylate polymer and an Arabian heavy asphaltene. The Arabian asphaltene is a filler obtained from Arabian heavy residue (Hasan, M.; Siddiqui, M. N. and Arab, M.: “Separation and Characterization of Asphaltenes From Saudi Arabian Crudes”, Fuel, August 1988, Volume 67, No. 8, 1131-1134—incorporated by reference in its entirety). The asphaltene is a complex molecular mixture obtained from a dispersion of crude oil with a mass fraction of 0 to 10% or more.

Glass transition temperature (Tg) is a macroscopic property which is the measure of relaxation behavior of methyl methacrylate and asphaltene composites. A glass transition temperature of the polymer asphaltene composite matrix is from 105 to 115° C. On addition of asphaltene filler, higher value of glass transition for composites is obtained that indicates better interaction of asphaltenes with the methyl methacrylate. This improvement in Tg may indicate the better dispersion and bonding between asphaltenes and methyl methacrylate. A similar behavior has been reported in literature for polymer chain dynamics (Oh, H. J. and Green, P. F. Polymer chain dynamics and glass transition in thermal polymer/nanoparticles mixtures. Nat. Mater, 2009, Vol 8, p. 139—incorporated by reference in its entirety). The molecules sit in between the chains and decrease the friction between the chains, causing roller actions and leading to higher Tg. A similar behaviour has been also reported in literature for epoxy/amine systems (Alzina C, Sbirrazzuoli N, Mija A. Hybrid nanocomposites: Advanced nonlinear method for calculating key kinetic parameters of complex cure kinetics. J Phys Chem B 2010; 114: 12480-12487; Alzina C, Mija A, Vincent L, Sbirrazzuoli N. Effects of incorporation of organically modified montmorillonite on the reaction mechanism of Epoxy/Amine cure. J Phys Chem B 2012; 116: 5786-5794—incorporated by reference in its entirety).

A weight average molecular weight of the methyl methacrylate polymer is from 1500 to 100,000.

A crystallization temperature (Tc) of the composite matrix is from 125 to 145° C. A high crystallization temperature is due to the filler content which hinders the polymer chains from settling easily in crystalline order. Thus, the presence of filler molecules increases the Tc.

A melting temperature of the composite matrix is from 150° C. to 170° C. The melting temperature has significance in the energy requirement during polymer processing and product formation. If Tm is higher, then higher energy will be required, increasing the cost.

A content ratio of the asphaltene to the methyl methacrylate is from 2.0 mg to 10.0 mg asphaltene to a fixed amount of 5.00 ml of methyl methacrylate (density of methyl methacrylate is 0.94 g/ml, so the amount of methyl methacrylate is 4.2 g).

Optionally, the composite matrix does not comprise any aromatics or polyaromatics other than asphaltene.

In the present invention, asphaltenes are isolated by heating an Arabian heavy residue in a small amount of a solvent to homogenize the solution. Then, more of the solvent is added to the residue solution, and is stirred with a stirrer and placed on a water bath. The solvent is selected from n-paraffinic hydrocarbons such as n-hexane or n-heptane. The solvent used in this study was n-heptane. The asphaltenes are isolated by mixing 10 g Arab heavy residue with 300 ml of n-heptane (1:30, w:v ratio).

The solution is then heated to a temperature of from 25° C. to 90° C. on the steam bath with continuous stirring for a time period of 1 to 2 hours to maximize solubility. Afterwards, the residue solution is covered and cooled at room temperature for a time period of 20 to 24 hours. The long cooling time produces more efficient precipitation of asphaltenes.

Then, the residue solution is filtered and washed several times, preferably 4 to 5 times, with n-heptane solvent, to remove any traces of maltenes, until the washings are colorless. After the washings, the recovered asphaltenes are dried in an oven for 2 to 3 hours at a temperature of from 100° C. to 105° C. to obtain a constant weight.

A method of preparing polymer asphaltene composites comprises, in the following order:
(1) mixing asphaltene with methyl methacrylate;
(2) heating the mixture with continuous stirring to disperse asphaltenes with methyl methacrylate homogeneously;
(3) optionally increasing the heat;
(4) adding a free radical initiator; and
(5) polymerizing.

In step (1), a concentration of asphaltene mixed with methyl methacrylate is from 0.4 mg asphaltene/ml methyl methacrylate to 2 mg asphaltene/ml methyl methacrylate, preferably from 0.6 mg asphaltene/ml methyl methacrylate to 1.5 mg asphaltene/ml methyl methacrylate. In step (2), the heating temperature is from 40 to 70° C., preferably from 45 to 65° C., and especially preferably about 60° C.

In step (3), the heat increase is from 10 to 30° C., yielding an increased temperature ranging from 50 to 100° C., preferably from 70 to 90° C., and especially preferably about 80° C.

In step (4), the free radical initiator is selected from the group consisting of 2,2-azobis-(2-methylpropionitrile) (AIBN), benzoyl peroxide and peroxybenzoic acid. 2,2-azobis-(2-methylpropionitrile) (AIBN) free radical initiator was used. The free radical initiator is added in a small amount, ranging from 2.0 mg to 10.0 mg at the increased temperature.

In step (5), the reaction material is polymerized preferably within 15 to 20 minutes.

### Examples

### Isolation of Asphaltenes

10 g Arab heavy residue was transferred to a 100-ml beaker and heated with a very small amount of n-heptane in order to homogenize the solution. This residue solution was carefully transferred to a 1-L flask and 300 ml of n-heptane was added to the same flask. The flask containing the residue solution was fitted with a mechanical stirrer and placed on a water bath. The residue solution was heated at 90° C. on the steam bath with continuous stirring for about 2 hours in order to maximize the solubility of residue in n-heptane. After two hours of mixing, the residue solution covered with aluminum foil was left on the working bench to cool at room temperature for about 24 hours. The residue solution was filtered using a Millipore filtration apparatus with 0.8 μm (37 mm) pore size filter paper. All asphaltene filtered was collected in a 100-ml beaker and washed several times with small portions of n-heptane, in order to remove any traces of maltenes, until the washings became colorless. The recovered asphaltenes were dried in an oven for about 2 hours at 105° C. to obtain a constant weight.

### Preparation of Asphaltene-Polymethyl Methacrylate Composites

Different amount of asphaltenes in 5 ml of methyl methacrylate were heated at 60° C. with continuous stirring in order to disperse asphaltenes with MMA homogeneously. This gave a light brown color. On increasing the temperature to 80° C., the solution turned to a dark brown color without any polymerization. Then, a small amount of a free radical initiator, 2,2-azobis-(2-methylpropionitrile) (AIBN), was added at 80° C. and the reaction material was polymerized within 15-20 minutes. Table-1 shows the different combination of MMA and asphaltenes. The free radical generation from AIBN is given below.

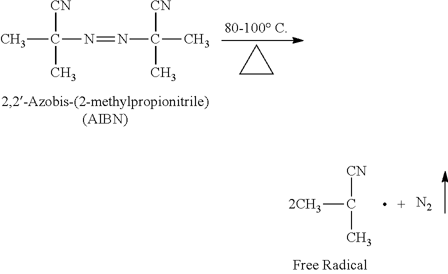

TABLE 1
Preparation of different MMA-asphaltene composites

| Sample | Methyl methacrylate | Asphaltenes | | AIBN |
|---|---|---|---|---|
| MA | Pure | None | | None |
| MA1 | 5 ml | 2.0 | mg | Yes |
| MA2 | 5 ml | 5.0 | mg | Yes |
| MA3 | 5 ml | 7.5 | mg | Yes |
| MA4 | 5 ml | 9.0 | mg | Yes |
| MA5 | 5 ml | 10.0 | mg | Yes |

The composite materials formed were characterized by using FT-IR, TGA, DSC and DMA techniques.

### Fourier-Transform Infrared (FT-IR)

Perkin-Elmer, Spectrum One instrument was used. The chemical structure of the neat methyl methacrylate and PMMA-based composites were confirmed by recording their IR spectra. The resolution used was 4 cm⁻¹. The recorded wave number range was from 4000 to 400 cm⁻¹ and 32 scans were averaged to reduce noise. Thin films were used in each measurement, formed by a hydraulic press.

### Thermogravimetric Analysis (TGA)

TGA was performed on a Pyris 1 TGA (Perkin Elmer) thermal analyzer equipped with a sample pan made of Pt. Samples of about 5-8 mg were used. They were heated from ambient temperature to 600° C. at a heating rate 10° C./min, under a 20 ml/min nitrogen gas flow.

### Differential Scanning Calorimetry (DSC)

In order to estimate the glass transition temperature of every nanocomposite prepared, the DSC-Diamond (Perkin-Elmer) was used. Approximately 10 mg of each sample were weighed, put into the standard Perkin-Elmer sample pan, sealed and placed into the appropriate position of the instrument. Subsequently, they were initially heated to 180° C. at a rate of 10° C. min⁻¹ to ensure complete polymerization of the residual monomer. Following, the samples were cooled to 0° C. and their glass transition temperature was measured by heating again to 180° C. at a rate of 20° C. min⁻¹.

### Dynamic Mechanical Thermal Analysis (DMTA)

Thermal mechanical tests were done using a dynamic mechanical analysis instrument (Perkin Elmer Diamond DMA Technology SII) in sinusoidal three-point bending mode. The vibration frequency was 1 Hz, the stress 4000 mN and the amplitude 10 mμ. The temperature was varied from 25 to 130° C. with a scanning rate of 3° C./min in a nitrogen atmosphere. Rod-like specimens were prepared with dimensions 2×2×40 mm.

Storage modulus, E′; Loss modulus, E″; Phase angle, tan δ=E″/E′

The structure of the composites formed were characteristics with FTIR analysis. Thermal degradation characteristics of the composites formed were measured with TGA and glass transition temperature was measured with DSC. In addition, the viscoelastic properties of the composites were studied by dynamic mechanical analysis (DMA). It was found that the thermal stability and viscoelastic properties of the methyl methacrylate composites formed were significantly improved with the addition of asphaltene as filler.

### FTIR Analysis

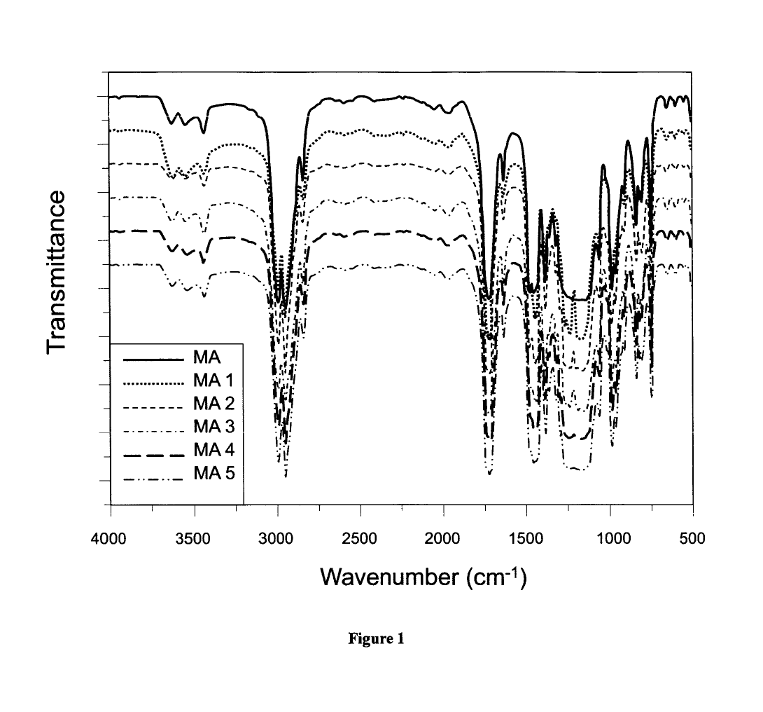

Infrared spectroscopy is probably the most extensively used method for the investigation of polymer structure and functional groups. FTIR spectra of the pure methyl methacrylate (MMA) and its composites were recorded and overlaid spectra are given in FIG. 1. The FTIR spectra of the composites made in the present study show the asymmetric stretching vibrations of —CH₃ groups in the region 2985-2994 cm⁻¹. The symmetric stretching vibrations of the —CH₃ group seem to overlap with the stretching vibrations of the —CH₂ group in the region 2952-2862 cm⁻¹. The intensity of the signal at 2869 cm⁻¹ is very high and may be due to the aliphatic side chain of asphaltenes. There are significantly visible multiplets for these copolymers in the region 3400-3600 cm⁻¹. The absorption bands in the region 1451-1443 cm⁻¹ result from the bending vibrations of —CH₃ group, and the bending vibrations of —CH₂ group is found in a slightly higher region in the IR absorption spectra. The rocking vibrations of —CH₂ can be observed in the region 757-755 cm⁻¹.

### DSC Analysis

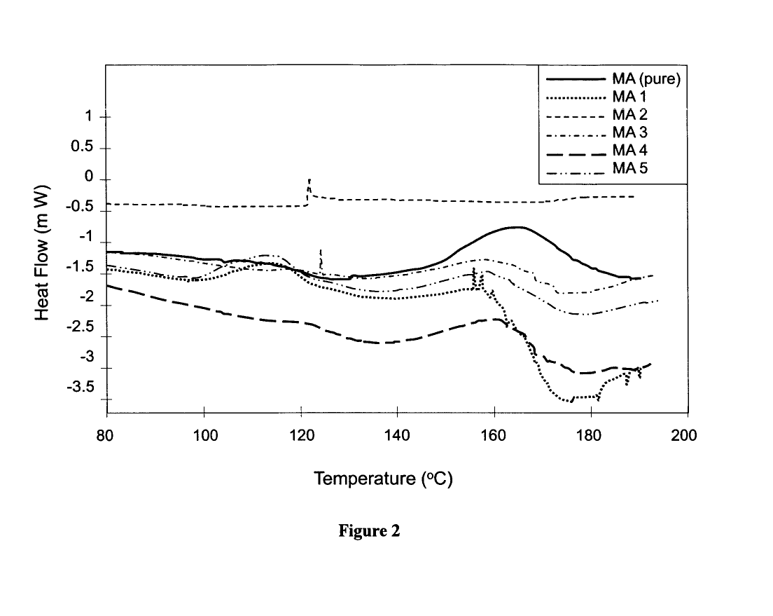

The glass transition temperature of pure MMA and its asphaltene composites were measured using DSC as shown in FIG. 2. For the above samples it can be inferred that sample MA3 had the highest glass transition temperature of about 110° C. On addition of some asphaltene filler, its molecules sit in between the chains and decrease the friction between the chains, causing roller actions leading to lower Tg.

The crystallization temperature is the highest for MA5 around 137° C., which is due to the filler content which hindered settling in order. The polymer chains cannot settle themselves easily in crystalline order due to presence of filler molecules and thus the Tc is higher. The Tc is lowest for MA (pure).

The melting temperature is highest for MA (pure) and lowest for MA2.

### TGA Analysis

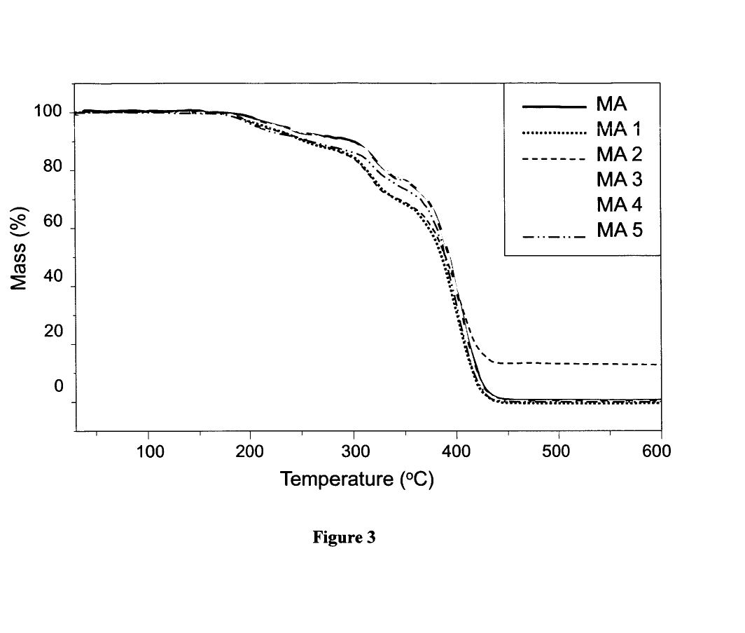

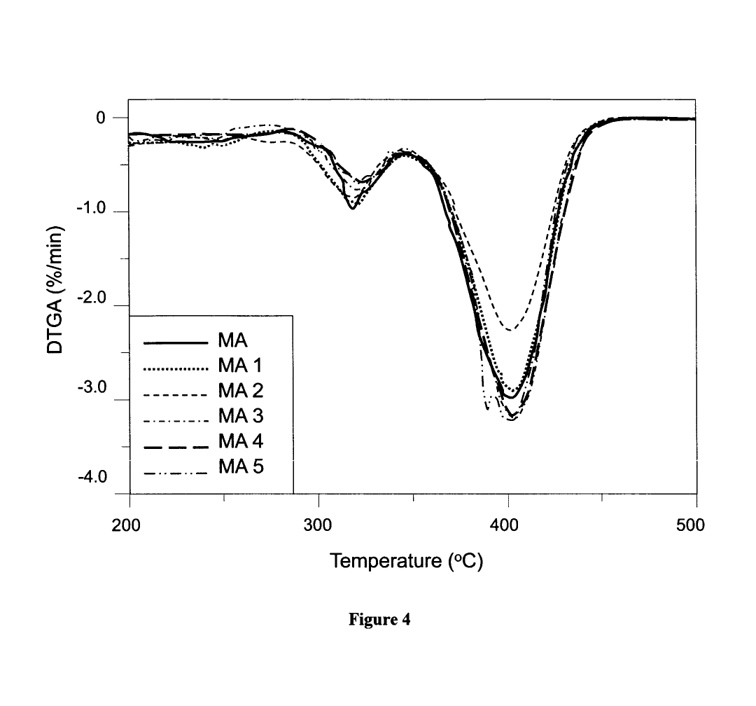

The thermal degradation of the neat MMA and composite used in this study were investigated and TGA curves showing the mass loss and thermal degradation are shown in FIGS. 3 and 4. The thermal degradation of methyl methacrylate samples were studied and the figures show the mass loss curves with respect to temperature. From the curve it is inferred that highest thermal stability is shown by MA4 and MA5 and the highest recorded onset is found to be 315° C. The other samples show varying thermal stability. It is seen that there is significant improvement in the thermal property of the MA4 as compared to neat Ma as seen in the curve which shifts to higher temperatures. This change and improvement is attributed to filler which is used in this study. The origin of this increase in the decomposition temperatures has been attributed to the ability of asphaltene to obstruct volatile gas produced by thermal decomposition. Accordingly, thermal decomposition begins from the surface of the composites, leading in an increase of the asphaltene contents and the formation of a ‘protection layer’ by the clay. This so-called ‘barrier model’ may work well for char-forming polymers (Alzina C, Sbirrazzuoli N, Mija A. Hybrid nanocomposites: Advanced nonlinear method for calculating key kinetic parameters of complex cure kinetics. J Phys Chem B 2010; 114: 12480-12487; Alzina C, Mija A, Vincent L, Sbirrazzuoli N. Effects of incorporation of organically modified montmorillonite on the reaction mechanism of Epoxy/Amine cure. J Phys Chem B 2012; 116: 5786-5794—incorporated by reference in its entirety).

### DMA Analysis

Table 2 has characteristic thermal transitions estimated from the peak in tan S. The highest glass transition temperature was recorded for the MA2 sample which was 108.60. The MA1 and MA4 also showed significantly higher Tg. The storage modulus values E′ remained almost same for all the samples in plateau region below the glass transition temperature which was highest for neat MA sample. This can be attributed to cross linking between the chains of the polymer due to addition of asphaltene.

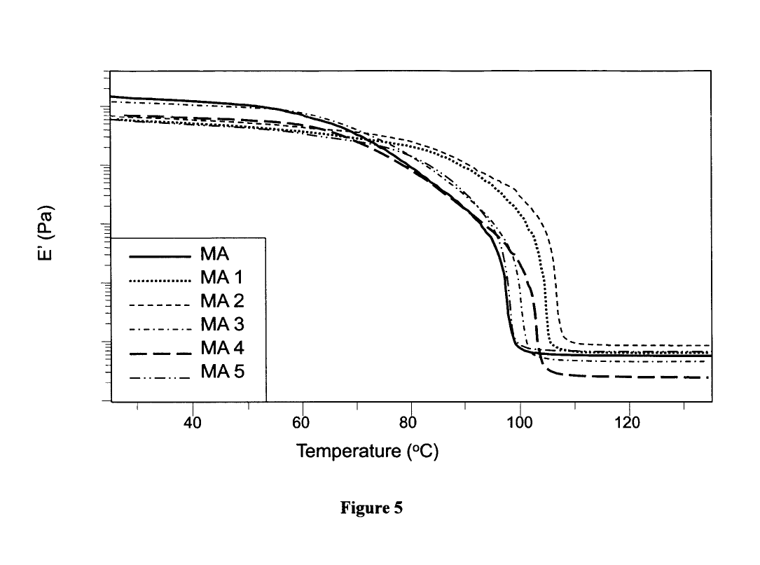

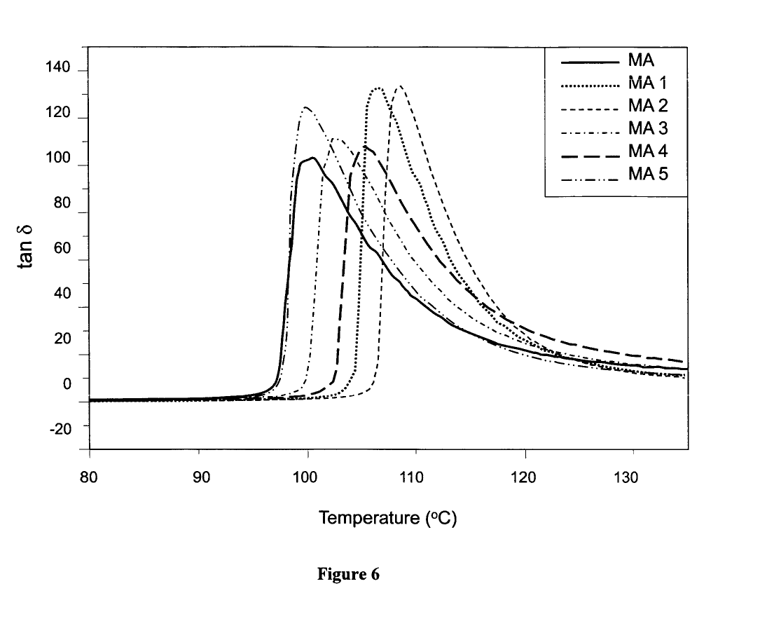

The sample MA2 shows higher melts temperature and comparably equivalent mechanical strength. It also shows least loss modulus so it will require least energy during processing. The FIGS. 5 and 6 show the Storage modulus and phase angle of neat MMA and asphaltene composites respectively.

TABLE 2
Characteristic thermal transitions estimated from the peak in tan δ

| Sample | Tg |
|---|---|
| MA | 100 |
| MA1 | 106.6 |
| MA2 | 108.6 |
| MA3 | 102.7 |
| MA4 | 105.4 |
| MA5 | 100 |

Synthesis and characterization of composites based on the Methyl Methacrylate and Arabian asphaltene were prepared and studied. The structures of the composites formed were characterized by FTIR analysis. Thermal degradation characteristics of the composites formed were measured with TGA and glass transition temperature was measured with DSC. In addition, the viscoelastic properties of the composites were studied by dynamic mechanical analysis (DMA). The thermal stability and viscoelastic properties of the PMMA composites formed were significantly improved with the addition of asphaltene as filler.

1. A polymer asphaltene composite matrix, comprising a methyl methacrylate polymer and an Arabian heavy asphaltene.

2. The composite matrix of claim 1, wherein the Arabian asphaltene is the only filler present.

3. The composite matrix of claim 1, wherein the asphaltene is a complex molecular mixture obtained from crude oil.

4. The composite matrix of claim 1, consisting essentially of the methyl methacrylate polymer and the Arabian heavy asphaltene.

5. The composite matrix of claim 1, consisting of the methyl methacrylate polymer and the Arabian heavy asphaltene.

6. The composite matrix of claim 1, wherein the composite matrix does not comprise any aromatic or polyaromatic material other than the asphaltene.

7. The composite matrix of claim 1, a content ratio of the asphaltene to the methyl methacrylate is from 0.1 mg to 100 mg asphaltene to 1 g polymer.

8. The composite matrix of claim 1, wherein a weight average molecular weight of the methyl methacrylate polymer is from 500 to 500,000.

9. A method of forming a polymer asphaltene composite, comprising mixing a methyl methacrylate monomer with an asphaltene; and then polymerizing the methyl methacrylate, to form the polymer asphaltene composite.

10. The method of claim 9, wherein the polymerization is an in-situ polymerization.

11. The method of claim 10, comprising performing the in-situ polymerization with a dispersion of the asphaltene in a styrene monomer mixture.

12. The method of claim 9, comprising, in the following order:
mixing the asphaltene with the methyl methacrylate polymer;
heating the mixture with stirring to disperse the asphaltenes with the methyl methacrylate homogeneously;
adding a free radical initiator; and
polymerizing the reaction material.

13. The method of claim 12, wherein the free radical initiator is 2,2-azobis-(2-methylpropionitrile).
